(19) United States
(12) Patent Application Publication
(10) Pub. No.: US 2024/0328297 A1
(43) Pub. Date: Oct. 3, 2024

(54) FEATURE DETECTION USING MACHINE LEARNING

(71) Applicant: SAUDI ARABIAN OIL COMPANY, Dhahran (SA)

(72) Inventors: Bingbing Sun, Dhahran (SA); Nasher M. Albinhassan, Dammam (SA)

(73) Assignee: SAUDI ARABIAN OIL COMPANY, Dhahran (SA)

(21) Appl. No.: 18/191,613

(22) Filed: Mar. 28, 2023

(51) Int. Cl. E21B 44/00; G01V 1/28

(52) U.S. Cl. CPC E21B 44/00; G01V 1/282; E21B 2200/20; E21B 2200/22; G01V 2210/6222

(57) ABSTRACT

Methods and systems are disclosed. The methods may include obtaining M training pairs and training a machine learning (ML) model using the M training pairs. The methods may further include obtaining geological data from a subterranean region of interest and, for each of a sequence of N windows, inputting the geological data and an (n−1)th predicted feature image within an (n−1)th window into the ML model and producing an nth predicted feature image within an nth window from the ML model. The geological data includes a seismic image and a manifestation of a feature within the subterranean region of interest. The methods may still further include determining the predicted feature image for the geological data associated with the subterranean region of interest using the N predicted feature images. The predicted feature image includes a labeled manifestation of the feature.

### BACKGROUND

In the oil and gas industry, a seismic image of a subterranean region of interest may be used to identify the location and size of structural features within the subterranean region of interest. Structural features include interfaces between layers of rock (“horizons”) and faults. Current methods used to identify structural features within the subterranean region of interest may include the use of seismic attributes and mathematical models, both of which may require significant user interaction. Further, current methods may not consider spatial dependencies of the structural features, inherently allow an uncertainty analysis to be performed, or be automated.

Following the proper identification of structural features within the subterranean region of interest, the structural features may be used, at least in part, to inform a geological model of and/or identify a drilling target within a hydrocarbon reservoir within the subterranean region of interest.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method. The method includes obtaining M training pairs. Each of the M training pairs includes an mth training geological data patch and an associated mth training feature image patch. Further, the mth training geological data patch includes an mth training seismic image patch and an mth manifestation of a feature. Further still, the associated mth training feature image patch includes an mth labeled manifestation of the feature. The method further includes training a machine learning (ML) model using, at least in part, the M training pairs. The ML model is trained to produce an nth predicted feature image within an nth window from, at least in part, geological data. Further, M and N are integers greater than or equal to one, m is an integer between 1 and M, inclusive, and n is an integer between 1 and N, inclusive.

In general, in one aspect, embodiments relate to a method. The method includes obtaining geological data from a subterranean region of interest and, for each of a sequence of N windows, inputting the geological data and an (n−1)th predicted feature image within an (n−1)th window into the ML model and producing an nth predicted feature image within an nth window from the ML model. The geological data includes a seismic image and a manifestation of a feature within the subterranean region of interest. Further, N is an integer greater than or equal to one and n is an integer between 1 and N, inclusive. The method further includes determining the predicted feature image for the geological data associated with the subterranean region of interest using the N predicted feature images. The predicted feature image includes a labeled manifestation of the feature.

In general, in one aspect, embodiments relate to a system. The system includes a seismic processing system configured to receive geological data from a subterranean region of interest and, for each of a sequence of N windows, input the geological data and an (n−1)th predicted feature image within an (n−1)th window into the ML model and produce an nth predicted feature image within an nth window from the ML model. The geological data includes a seismic image and a manifestation of a feature within the subterranean region of interest. Further, N is an integer greater than or equal to one and n is an integer between 1 and N, inclusive. The seismic processing system is further configured to determine the predicted feature image for the geological data associated with the subterranean region of interest using the N predicted feature images. The predicted feature image includes a labeled manifestation of the feature. The system further includes a seismic interpretation workstation configured to identify a drilling target within a hydrocarbon reservoir within the subterranean region of interest based, at least in part, on the predicted feature image.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 illustrates a seismic survey in accordance with one or more embodiments.

FIG. 2 displays a seismic image in accordance with one or more embodiments.

FIG. 3 illustrates a well logging system in accordance with one or more embodiments.

FIG. 4 illustrates an autoregressive process in accordance with one or more embodiments.

FIG. 5 illustrates a neural network in accordance with one or more embodiments.

FIG. 6A displays a mth training seismic image patch in accordance with one or more embodiments.

FIG. 6B displays an associated mth training feature image patch in accordance with one or more embodiments.

FIG. 7 displays a predicted feature image in accordance with one or more embodiments.

FIG. 8 describes a method in accordance with one or more embodiments.

FIGS. 9A and 9B each display a predicted probabilistic feature image in accordance with one or more embodiments.

FIG. 10 illustrates a drilling system in accordance with one or more embodiments.

FIG. 11 illustrates a computer system in accordance with one or more embodiments.

FIG. 12 illustrates a series of systems in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a window” includes reference to one or more of such windows.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

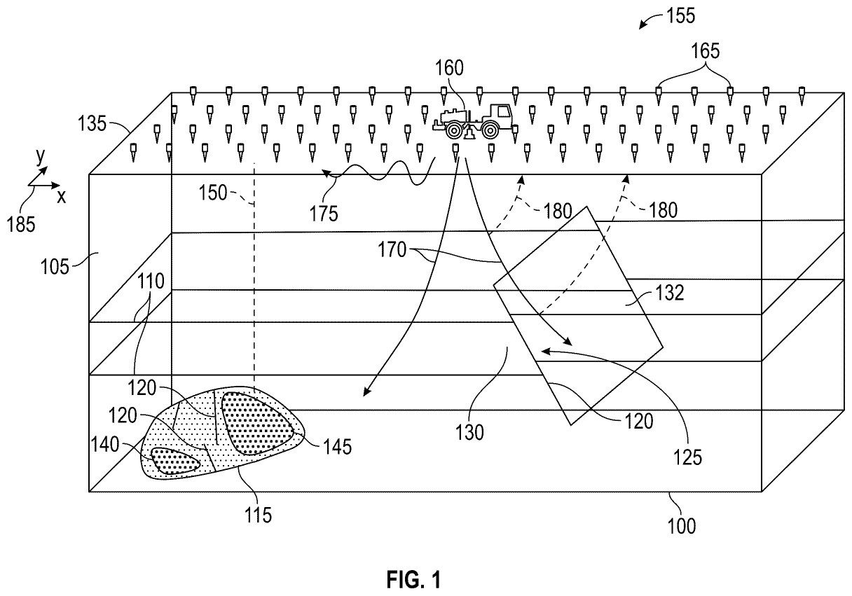

In the following description of FIGS. 1-12, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Methods and systems are disclosed to determine a predicted feature image from geological data, at least in part, using a machine learning (ML) model. The geological data includes a seismic image. The seismic image may display an unlabeled manifestation of a structural feature, such as a horizon or fault. In turn, the predicted feature image produced from the ML model may display a labeled manifestation of the structural feature. In some embodiments, the predicted feature image may use a binary system to label if a manifestation of the structural feature exists at each pixel location or not. In other embodiments, the predicted feature image may use a value of a seismic attribute to label a manifestation of the structural feature at each pixel location. In still other embodiments, a predicted probabilistic feature image may assign a value of a statistical measure to each pixel location to quantify the likelihood of the structural feature existing or not at each pixel location.

The present disclosure may be an improvement over current methods used to identify a manifestation of a structural feature within a seismic image. Current methods may rely on an interpreter to manually identify the manifestation of the structural feature within the seismic image. Other current methods may include determining a value of a seismic attribute at each position within the seismic image and applying a threshold to the values to locate the manifestation of the structural feature. Seismic attributes may include, but are not limited to, semblance, coherence, variance, and curvature. Still other current methods may include applying a mathematical model to the seismic image to locate the manifestation of the structural feature. Current methods may not consider spatial dependencies of the structural feature within the subterranean region of interest. However, the present disclosure may use an autoregressive process in which spatial dependencies are considered. Further, current methods may be deterministic and, thus, an uncertainty analysis cannot be performed. However, the present disclosure may use a stochastic process, which, in turn, may be used to perform an uncertainty analysis.

Turning to FIG. 1, FIG. 1 illustrates a subterranean region of interest 100 in accordance with one or more embodiments. The subterranean region of interest 100 may be made up of layers of rock 105 separated by geological boundaries often denoted horizons 110. The subterranean region of interest 100 may contain a hydrocarbon reservoir 115. The hydrocarbon reservoir 115 may be rock 105 filled with fluid such as oil, gas, water, brine, and/or a combination thereof. The rock 105 and the hydrocarbon reservoir 115 within the subterranean region of interest 100 may include one or more faults 120. A fault 120 may be identified as a break or discontinuity within rock 105 where the rock 105 to one side of the break (i.e., a fault block) is slipping or has slipped relative to the fault block on the opposite side of the break. In some cases, the fault block above the fault 120 may be denoted the hanging wall 125. The fault block below the fault 120 may then be denoted the footwall 130. Hereinafter, “structural features” or simply “features” within the subterranean region of interest 100 may include, but are not limited to, horizons 110, faults 120, and hydrocarbon reservoirs 115.

Faults 120 may be classified in terms of the direction of slip along the fault plane 132. General types of faults 120 include, but are not limited to, normal, reverse, and strike-slip. In a normal fault, the hanging wall 125 may slip downward relative to the footwall 130 due to tensile force. In a reverse fault, as shown in FIG. 1, the hanging wall 125 may slip upward relative to the footwall 130 due to compressive force. In a strike-slip fault, the fault blocks may slip parallel to the fault plane 132 due to shear stress. Note that the present disclosure should in no way be limited based on the type, sub-type, orientation, or any other characteristic associated with a fault 120, or associated with any other structural feature.

Faults 120 within the hydrocarbon reservoir 115 may control, at least in part, the vertical and lateral distribution of hydrocarbons by creating compartments 140 within the hydrocarbon reservoir 115. Because some faults 120 may leak, seal, or both leak and seal hydrocarbons over time, some compartments 140 may often not contain hydrocarbons while other compartments 140 may often contain hydrocarbons. The faults 120 may also be conduits for which hydrocarbons flow. As such, it may be useful to identify the location of the faults 120 within the subterranean region of interest 100. In turn, compartments 140 that often contain hydrocarbons may be identified as a drilling target 145 using, at least in part, the identified locations of the faults 120. The size of the compartment 140 identified as the drilling target 145 may also be determined using, at least in part, the identified locations of the faults 120. A wellbore path 150 may then be planned to intersect the drilling target 145 while also avoiding the faults 120 as the faults 120 may be considered drilling hazards.

A seismic survey of the subterranean region of interest 100 may be used, at least in part, to identify the location and size of faults 120, and other features like horizons 110, within the subterranean region of interest 100. FIG. 1 further illustrates a seismic survey in accordance with one or more embodiments. The seismic survey may be performed using a seismic acquisition system 155. The seismic acquisition system 155 may include a seismic source 160 and seismic receivers 165 positioned on the surface of the earth 135.

The seismic survey may utilize the seismic source 160 that is configured to generate radiated seismic waves 170 (i.e., emitted energy, wavefield). The type of seismic source 160 may depend on the environment in which it is used. For example, on land, the seismic source 160 may be a vibroseis truck or an explosive charge. In water, the seismic source 160 may be an airgun. The radiated seismic waves 170 may return to the surface of the earth 135 as refracted seismic waves (not shown) or may be reflected by horizons 110 and return to the surface of the earth 135 as reflected seismic waves 180. The radiated seismic waves 170 may also propagate along the surface as Rayleigh waves or Love waves, collectively known as “ground roll” 175. Vibrations associated with ground roll 175 do not penetrate far beneath the surface of the earth 135 and, hence, are not influenced by, nor contain information about, portions of the subterranean region of interest 100 where hydrocarbon reservoirs 115 typically reside. Seismic receivers 165 located on or near the surface of the earth 135 are configured to detect reflected seismic waves 180, refracted seismic waves, and ground roll 175.

Assume the position of the seismic source 160 is denoted (xₛ,yₛ) and the position of each seismic receiver 165 is denoted (xᵣ,yᵣ), where x and y represent orthogonal axes 185 on the surface of the earth 135 above the subterranean region of interest 100. The seismic trace, or time-series data, recorded by each seismic receiver 165 may then be denoted S(xₛ,yₛ,xᵣ,yᵣ,t) and described as seismic data.

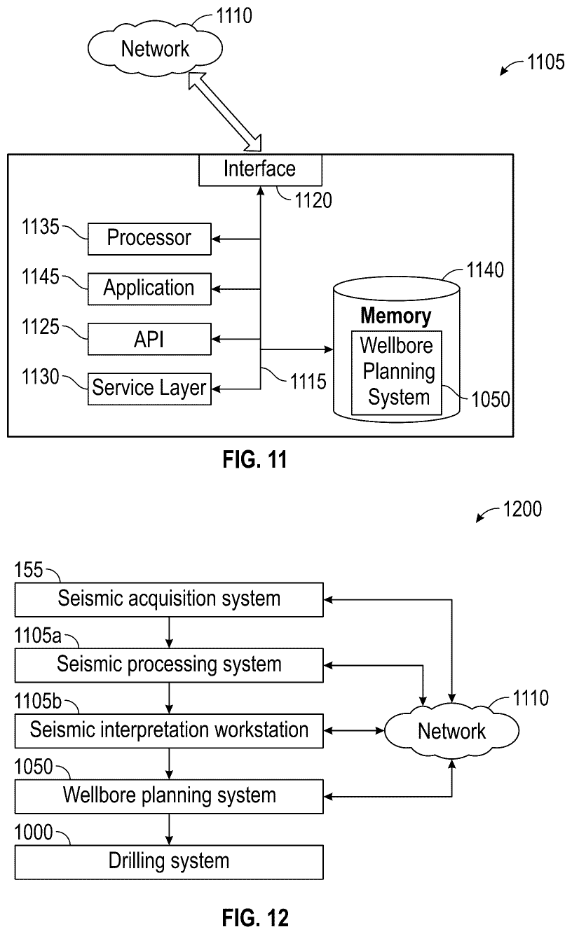

The seismic data may be processed using a seismic processing system, which will be discussed in reference to FIG. 11, to ultimately determine a seismic image. The seismic data may be processed by methods that include migration, stacking, and filtering to produce seismic traces with a high signal-to-noise ratio. The horizons 110 may manifest as large amplitudes within the seismic image. Faults 120 may manifest as discontinuities within the seismic image. How a feature manifests within a seismic image, or other geological data, should in no way limit the scope of the disclosure.

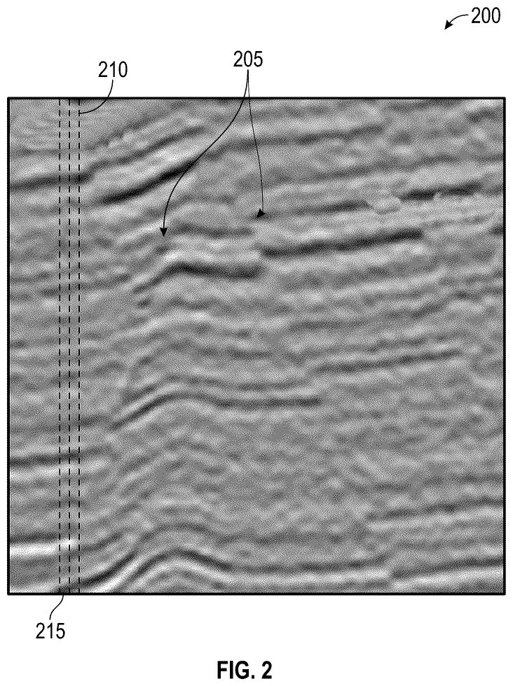

FIG. 2 displays a seismic image 200 in accordance with one or more embodiments. The seismic image 200 may display unlabeled manifestations (or simply “manifestations”) of one or more features 205, such as faults 120, using pixels. While FIG. 2 displays a two-dimensional seismic image 200, the seismic image 200 may be any higher dimensionality without departing from the scope of the disclosure.

Features within the subterranean region of interest 100 and manifestations of those features 205 within the seismic image 200 may be spatially dependent. Spatial dependence may be defined as the propensity for neighboring locations that possess a feature or manifestation of a feature to influence whether the location of interest also possesses that feature or manifestation of that feature (i.e., for features to exhibit some form of spatial continuity). For example, in some subterranean regions of interest 100, a horizon 110 may be largely lateral as FIG. 1 illustrates. Such a horizon 110 may then be considered laterally spatially dependent. As such, there may be a greater propensity for a horizon 110 to continue to exist in a location laterally neighboring an already identified portion of the horizon 110. Similarly, faults 120 may manifest as spatially dependent along a dip. As such, there may be a greater propensity for a fault 120 to continue along the dip already identified as a portion of the fault 120 as the seismic image 200 displayed in FIG. 2 shows.

Any data, such as seismic image 200, may be partitioned into a sequence of N windows, where N is an integer greater than or equal to one. The variable n maintains a count of the N windows. As such, n is an integer between 1 and N inclusive of 1 and N where n is the current window of interest. For example, if N=2, the sequence of two windows includes a first window and a second window each of which may be generically denoted an nth window. The sequence of N windows may be organized by position where an nth window 210 follows and neighbors an (n−1)th window 215 as shown in FIG. 2. In some embodiments, information within the (n−1)th window 215 may be used to determine, at least in part, information within the nth window 210.

While FIG. 2 shows each window as a collection of one or more neighboring columns of pixels, each window may alternatively be a collection of one or more neighboring pixels, a collection of one or more neighboring rows of pixels, or, if the seismic image is three dimensional, a collection of one or more neighboring vertical planes of pixels, or a collection of one or more neighboring horizontal planes of pixels. A plane of pixels may also be referred to as an in-line section, crossline section, or time-slice section depending on the orientation of the one or more planes of pixels.

While a seismic image, such as seismic image 200, may display unlabeled manifestations of a feature 205, other data may also display unlabeled manifestations of the feature 205. Other data may include, but are not limited to, well logs, a seismic velocity model (hereinafter also “velocity model”), and facies information. Hereinafter, “geological data” may include only a seismic image, such as seismic image 200, or geological data may include a seismic image, such as seismic image 200, and any other data, such as those previously listed, pertaining to the subterranean region of interest 100.

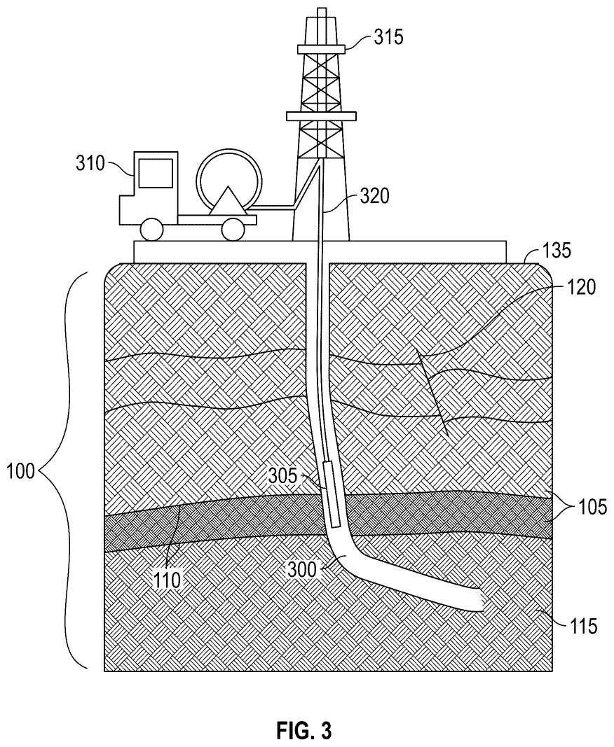

The well logs may be acquired downhole within a wellbore 300 located within the subterranean region of interest 100 using a well logging system 305 as illustrated in FIG. 3. Prior to deploying the well logging system 305 downhole, the wellbore 300 may be partially or completely drilled within the subterranean region of interest 100. The wellbore 300 may traverse layers of rock 105 separated by horizons 110, faults 120, and/or other structural features before penetrating the hydrocarbon reservoir 115.

Following the removal of a drilling system, the well logging system 305 may be lowered into the wellbore 300. The well logging system 305 may be supported by a truck 310 and derrick 315 above ground. For example, the truck 310 may carry a conveyance mechanism 320 used to lower the well logging system 305 into the wellbore 300. The conveyance mechanism 320 may be a wireline, coiled tubing, or drillpipe that may include means to provide power to the well logging system 305 and a telemetry channel from the well logging system 305 to the surface of the earth 135. In some embodiments, the well logging system 305 may be translated along the depth of the wellbore 300 to acquire a well log over multiple depth intervals.

The well logging system 305 may be, but is not limited to, an acoustic logging tool, acoustic image logging tool, and resistivity image logging tool. Thus, the well log acquired from the well logging system 305 may be an acoustic log, acoustic image log, or resistivity image log. The well logs may display unlabeled manifestations of the feature 205 surrounding the wellbore 300. In some embodiments, one or more well logs may display sub-seismic unlabeled manifestations of the feature 205. In other words, one or more well logs may display unlabeled manifestations of the feature 205 that the seismic image 200 may not display because the size of the feature is below the resolution of the seismic image 200.

Turning to the other geological data, the velocity model may be determined from a seismic survey, a vertical seismic profile (VSP) survey, and/or a checkshot survey. Further, the facies information may be determined from outcrops and/or rock cores. Similar to the well logs, the velocity model and/or the facies information may display sub-seismic unlabeled manifestations of the feature 205.

The geological data may be used to produce a predicted feature image. Here, the predicted feature image includes labeled manifestations of the feature that are unlabeled within the geological data. The predicted feature image may be predicted from the geological data using an autoregressive process. In the context of this disclosure, autoregression may be defined as a process that, at least in part, predicts future values from previously predicted values. In some embodiments, the past values may be the predicted feature image within the (n−1)th window 215, hereinafter referred to as the (n−1)th predicted feature image. In other embodiments, the past values may be all or some of the predicted feature image within any of the previous windows less than n. The future values may be the predicted feature image within the nth window 210 that has yet to be predicted. In other words, the predicted feature image is being predicted within one window at a time in order of the sequence of N windows. As such, an autoregressive process may inherently consider the spatial dependencies of the feature. In some embodiments, the geological data and the (n−1)th predicted feature image within the (n−1)th window 215 may be used to produce the nth predicted feature image within the nth window 210. In other embodiments, the geological data and all or some of the predicted feature image within any of the previous windows less than n may be used to produce the nth predicted feature image within the nth window 210. This process may be repeated until the predicted feature image has been produced for all of the sequence of N windows.

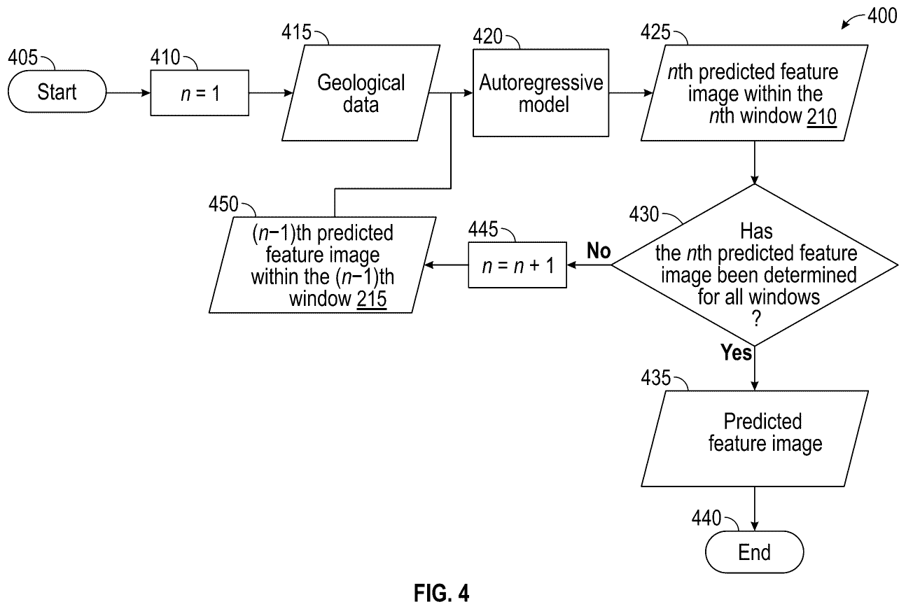

FIG. 4 illustrates an autoregressive process 400 in accordance with one or more embodiments. To start 405, n is set to one as shown in block 410. Recall that n=1, 2, . . . , N, where N is an integer greater than or equal to one. For the first window (i.e., the n=1 window) within the sequence of N windows, only the geological data 415 is input into an autoregressive model 420 to produce the first predicted feature image within the first window (i.e., the nth predicted feature image 425 within the nth window 210). Only the geological data 415 may be initially used as the predicted feature image has yet to be produced within any window as previous windows may not exist. A decision 430 is then made as to whether the nth predicted feature image 425 has been produced within all of the sequence of N windows. If not, n is updated as n=n+1 as shown in block 445 and the first predicted feature image within the first window is re-defined as the (n−1)th predicted feature image 450 within the (n−1)th window 215.

Now that n=2, the geological data 415 and the first predicted feature image within the first window (i.e., (n−1)th predicted feature image 450 within the (n−1)th window 215) may be input into the autoregressive model 420 to produce the second predicted feature image within the second window (i.e., the nth predicted feature image 425 within the nth window 210). This process is repeated for each of the sequence of N windows in order until the autoregressive model 420 has produced the nth predicted feature image 425 within all of the sequence of N windows. The N predicted feature images are then used to determine the predicted feature image 435 and the autoregressive process 400 ends 440.

Another process that may be used separately from or in conjunction with an autoregressive process 400 is a stochastic process (i.e., a random process). In a stochastic process, a stochastic model may produce a different output each time the same input is input into the stochastic model. For example, inputting the same geological data 415 into a stochastic model may ultimately produce a different predicted feature image 435 each time. Thus, an uncertainty analysis to quantify the variability of the predicted feature image 435 may be performed to determine a predicted probabilistic feature image. In turn, the predicted probabilistic feature image may be used to determine the certainty as to whether or not the feature exists or not at each pixel location within the predicted probabilistic feature image.

An autoregressive process 400 and/or a stochastic process may be implemented within a machine learning model. Machine learning (ML), broadly defined, is the extraction of patterns and insights from data. The phrases “artificial intelligence,” “machine learning,” “deep learning,” and “pattern recognition” are often convoluted, interchanged, and used synonymously. This ambiguity arises because the field of “extracting patterns and insights from data” was developed simultaneously and disjointedly among a number of classical arts like mathematics, statistics, and computer science. For consistency, the term machine learning, or machine learned, will be adopted herein. However, one skilled in the art will recognize that the concepts and methods detailed hereafter are not limited by this choice of nomenclature.

In some embodiments, the ML model may be a recurrent convolutional neural network (RCNN), such as the Pixel convolutional neural network (PixelCNN). An RCNN may be more readily understood as a specialized neural network (NN) and, from there, as a specialized convolutional neural network (CNN). Thus, a cursory introduction to an NN and a CNN are provided herein. However, note that many variations of an NN and CNN exist. Therefore, one of ordinary skill in the art will recognize that any variation of an NN or CNN (or any other ML model) may be employed without departing from the scope of this disclosure. Further, it is emphasized that the following discussions of an NN and CNN are basic summaries and should not be considered limiting.

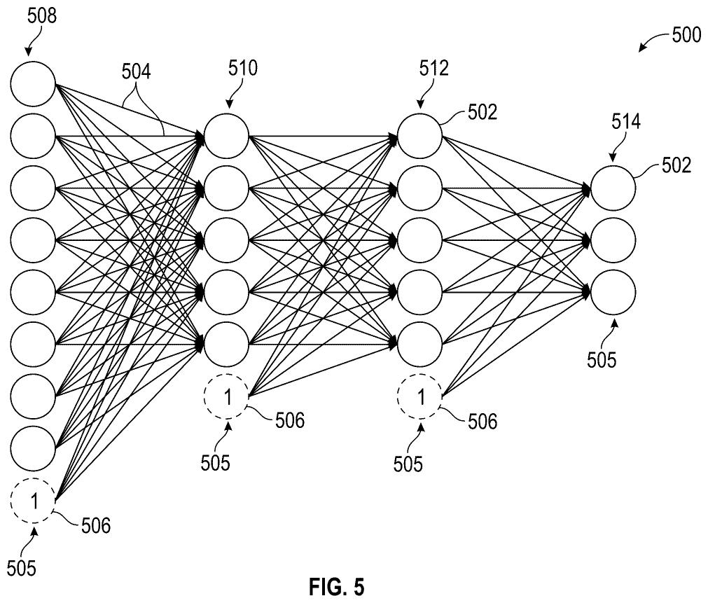

A diagram of an NN is shown in FIG. 5. At a high level, an NN 500 may be graphically depicted as being composed of nodes 502 and edges 504. The nodes 502 may be grouped to form layers 505. FIG. 5 displays four layers 508, 510, 512, 514 of nodes 502 where the nodes 502 are grouped into columns. However, each group need not be as shown in FIG. 5. The edges 504 connect the nodes 502 to other nodes 502. Edges 504 may connect, or not connect, to any node(s) 502 regardless of which layer 505 the node(s) 502 is in. That is, the nodes 502 may be sparsely and residually connected. For example, in a recurrent neural network (RNN), nodes 502 in the output layer 514 may be connected by edges 504 to nodes 502 in the input layer 508 (though not shown in FIG. 5).

An NN 500 will have at least two layers 505, where the first layer 508 is the “input layer” and the last layer 514 is the “output layer.” Any intermediate layer 510, 512 is usually described as a “hidden layer.” An NN 500 may have zero or more hidden layers 510, 512. An NN 500 with at least one hidden layer 510, 512 may be described as a “deep” neural network or “deep learning method.” In general, an NN 500 may have more than one node 502 in the output layer 514. In these cases, the neural network 500 may be referred to as a “multi-target” or “multi-output” network.

Nodes 502 and edges 504 carry associations. Namely, every edge 504 is associated with a numerical value. The edge numerical values, or even the edges 504 themselves, are often referred to as “weights” or “parameters.” While training an NN 500, a process that will be described below, numerical values are assigned to each edge 504. Additionally, every node 502 is associated with a numerical value and may also be associated with an activation function. Activation functions are not limited to any functional class, but traditionally follow the form:

$$A = f ( {Σ}_{i ∈ ( incoming )} [ {( node value )}_{i} {( edge value )}_{i} ] ) , \qquad Equation ( 1 )$$

where i is an index that spans the set of “incoming” nodes 502 and edges 504 and f is a user-defined function. Incoming nodes 502 are those that, when viewed as a graph (as in FIG. 5), have directed arrows that point to the node 502 where the numerical value is being computed. Some functions ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node 502 in an NN 500 may have a different associated activation function. Often, as a shorthand, activation functions are described by the function ƒ by which it is composed. That is, an activation function composed of a linear function ƒ may simply be referred to as a linear activation function without undue ambiguity.

When the NN 500 receives an input, the input is propagated through the network according to the activation functions and incoming node values and edge values to compute a value for each node 502. That is, the numerical value for each node 502 may change for each received input while the edge values remain unchanged. Occasionally, nodes 502 are assigned fixed numerical values, such as the value of 1. These fixed nodes 506 are not affected by the input or altered according to edge values and activation functions. Fixed nodes 506 are often referred to as “biases” or “bias nodes” as displayed in FIG. 5 with a dashed circle.

In some implementations, the NN 500 may contain specialized layers 505, such as a normalization layer, pooling layer, or additional connection procedures, like concatenation. One skilled in the art will appreciate that these alterations do not exceed the scope of this disclosure.

The number of layers in an NN 500, choice of activation functions, inclusion of batch normalization layers, and regularization strength, among others, may be described as “hyperparameters” that are associated to the ML model. It is noted that in the context of ML, the regularization of a ML model refers to a penalty applied to the loss function of the ML model. The selection of hyperparameters associated to a ML model is commonly referred to as selecting the ML model “architecture.”

Once a ML model, such as an NN 500, and associated hyperparameters have been selected, the ML model may be trained. To do so, M training pairs may be provided to the NN 500, where M is an integer greater than or equal to one. The variable m maintains a count of the M training pairs. As such, m is an integer between 1 and M inclusive of 1 and M where m is the current training pair of interest. For example, if M=2, the two training pairs include a first training pair and a second training pair each of which may be generically denoted an mth training pair. In general, each of the M training pairs includes an input and an associated target output. Each associated target output represents the “ground truth,” or the otherwise desired output upon processing the input. During training, the NN 500 processes at least one input from an mth training pair in the form of an mth training geological data patch to produce at least one output. Each NN output is then compared to the associated target output from the mth training pair in the form of an mth training feature image patch.

Returning to the NN 500 in FIG. 5, the NN 500 may be trained by first assigning initial values to the edges 504. These values may be assigned randomly, according to a prescribed distribution, manually, or by some other assignment mechanism. Once edge values have been initialized, the NN 500 may act as a function such that it may receive an input from an mth training pair and produce an output. At least one input is propagated through the neural network 500 to produce an output. The M training pairs will be discussed in more detail below.

The comparison of the NN output to the associated target output from the mth training pair is typically performed by a “loss function.” Other names for this comparison function include an “error function,” “misfit function,” and “cost function.” Many types of loss functions are available, such as the log-likelihood function. However, the general characteristic of a loss function is that the loss function provides a numerical evaluation of the similarity between the NN output and the associated target output from the mth training pair. The loss function may also be constructed to impose additional constraints on the values assumed by the edges 504. For example, a penalty term, which may be physics-based, or a regularization term may be added. Generally, the goal of a training procedure is to alter the edge values to promote similarity between the NN output and associated target output for most, if not all, of the M training pairs. Thus, the loss function is used to guide changes made to the edge values. This process is typically referred to as “backpropagation.”

While a full review of the backpropagation process exceeds the scope of this disclosure, a brief summary is provided. Backpropagation consists of computing the gradient of the loss function over the edge values. The gradient indicates the direction of change in the edge values that results in the greatest change to the loss function. Because the gradient is local to the current edge values, the edge values are typically updated by a “step” in the direction indicated by the gradient. The step size is often referred to as the “learning rate” and need not remain fixed during the training process. Additionally, the step size and direction may be informed by previous edge values or previously computed gradients. Such methods for determining the step direction are usually referred to as “momentum” based methods.

Once the edge values of the NN 500 have been updated through the backpropagation process, the NN 500 will likely produce different outputs than it did previously. Thus, the procedure of propagating at least one input from an mth training pair through the NN 500, comparing the NN output with the associated target output from the mth training pair with a loss function, computing the gradient of the loss function with respect to the edge values, and updating the edge values with a step guided by the gradient is repeated until a termination criterion is reached. Common termination criteria include, but are not limited to, reaching a fixed number of edge updates (otherwise known as an iteration counter), reaching a diminishing learning rate, noting no appreciable change in the loss function between iterations, or reaching a specified performance metric as evaluated on the m training pairs or separate hold-out training pairs (often denoted “validation data”). Once the termination criterion is satisfied, the edge values are no longer altered and the neural network 500 is said to be “trained.”

Turning to a CNN, a CNN is similar to an NN 500 in that it can technically be graphically represented by a series of edges 504 and nodes 502 grouped to form layers 505. However, it is more informative to view a CNN as structural groupings of weights. Here, the term “structural” indicates that the weights within a group have a relationship, often a spatial relationship. CNNs are widely applied when the input also has a relationship. For example, the pixels of a seismic image, such as seismic image 200, have a spatial relationship where the value associated to each pixel is spatially dependent on the value of other pixels of the seismic image. Consequently, a CNN is an intuitive choice for processing geological data 415 that includes a seismic image and may include other spatially dependent data.

A structural grouping of weights is herein referred to as a “filter” or “convolution kernel.” The number of weights in a filter is typically much less than the number of inputs, where, now, each input may refer to a pixel in an image. For example, a filter may take the form of a square matrix, such as a 3×3 or 7×7 matrix. In a CNN, each filter can be thought of as “sliding” over, or convolving with, all or a portion of the inputs to form an intermediate output or intermediate representation of the inputs which possess a relationship. The portion of the inputs convolved with the filter may be referred to as a “receptive field.” Like the NN 500, the intermediate outputs are often further processed with an activation function. Many filters of different sizes may be applied to the inputs to form many intermediate representations. Additional filters may be formed to operate on the intermediate representations creating more intermediate representations. This process may be referred to as a “convolutional layer” within the CNN. Multiple convolutional layers may exist within a CNN as prescribed by a user.

There is a “final” group of intermediate representations, wherein no filters act on these intermediate representations. In some instances, the relationship of the final intermediate representations is ablated, which is a process known as “flattening.” The flattened representation may be passed to an NN 500 to produce a final output. Note that, in this context, the NN 500 is considered part of the CNN.

Like an NN 500, a CNN is trained. The filter weights and the edge values of the internal NN 500, if present, are initialized and then determined using the M training pairs and backpropagation as previously described.

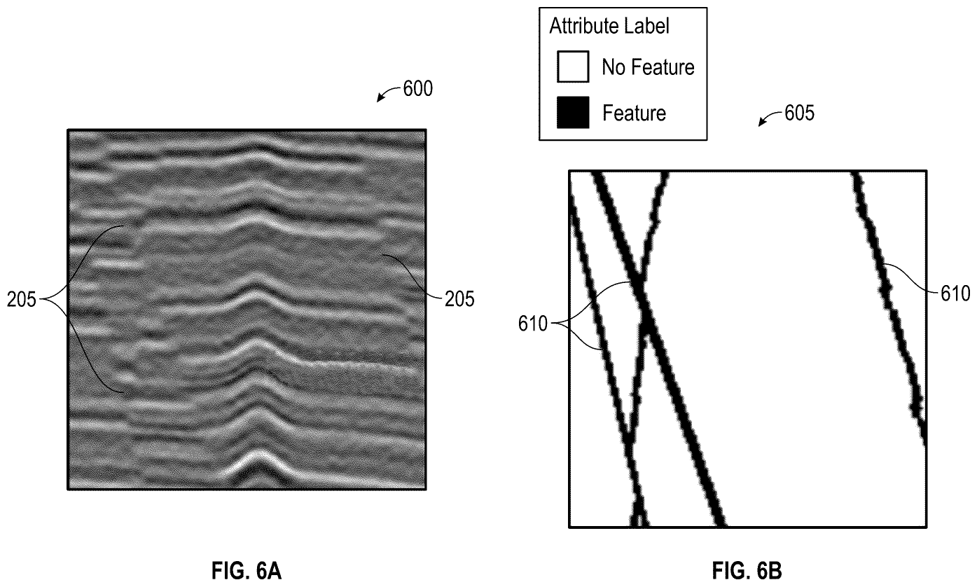

In the context of this disclosure, each mth training pair includes an mth training geological data patch as an input and its associated target output is an associated mth training feature image patch. Each mth training geological data patch includes an mth training seismic image patch 600 as shown in FIG. 6A. Like the seismic image, an mth training seismic image patch 600 displays unlabeled manifestations of a feature 205, such as a fault 120. FIG. 6B shows the associated mth training feature image patch 605 that displays labeled manifestations of the feature 610 that are unlabeled in the mth training seismic image patch 600. In some embodiments, the labeled manifestation of the feature 610 may be labeled using a binary system. For example, FIG. 6B shows the labeled manifestation of the feature 610 using a binary system where a black pixel indicates the manifestation of the feature and a white pixel indicates no manifestation of the feature. In other embodiments, the manifestation of the feature may be labeled using values of a seismic attribute, such as semblance.

In some embodiments, the M training geological data patches are collected from a seismic survey, VSP survey, checkshot survey, well logging tool, outcrops, and/or rock cores. In other embodiments, the M training geological data patches are synthetically generated through a modeling process. The modeling process may require prior knowledge about the subterranean region of interest 100, such as geological, geophysical, and petrophysical knowledge. The M training geological data patches may be considered truncated data that are referred to as “patches.”

The associated M training feature image patches may be determined using any of the current methods previously described. Recall that the current methods include, but are not limited to, manually interpreting each of the M training geological data patches, applying a threshold to values of a seismic attribute determined from each of the M training seismic image patches, or applying a mathematically model to each of the M training geological data patches to determine each of the associated M feature image patches. In practice, thousands to millions of (or even more) training pairs may be determined in this manner and used to train the ML model.

In some embodiments, a CNN may also be an RNN and, hereinafter, referred to as an RCNN. As such, previous outputs from the RCNN may be used as additional inputs to the RCNN for additional processing. For example, an RCNN may accept geological data 415 as an input to determine the first predicted feature image within the first window during a first iteration. For a second iteration, the RCNN may accept the geological data 415 and the first predicted feature image within the first window as an input to determine the second feature image within the second window. Such a process may continue until the N predicted feature images within the sequence of N windows is determined. As such, an RCNN may be considered an autoregressive process 400.

In some embodiments, a ML model may be “masked” such that the ML model may be used in an autoregressive manner. Masking may be defined as a method of indicating which node values should and should not be used to determine a ML output. In some embodiments, node values may not be used by setting edge values that affect those node values to zero. For example, assume the input layer 508 in the NN 500 in FIG. 5 receives the geological data 415 and the N predicted feature images within the sequence of N windows though only the first predicted feature image within the first window has been produced. To determine the second predicted feature image within the second window, all edge values associated with the predicted feature image within all but the first window may be set to zero. To then produce the predicted feature image within the third window, all edge values associated with the predicted feature image within all but the first window and the second window may be set to zero. This process continues until the N predicted feature images for the sequence of N windows has been determined. In other embodiments, node values may not be used by shifting input data such that the nodes 502 that receive data that will be determined in the future have no connection via an edge 504 to a neighboring layer.

For specificity, a ML model may include, but is not limited to, a long short-term memory (LSTM), a pixel recurrent neural network (pixelRNN), a pixel convolutional neural network (pixelCNN), a pixelCNN++, a pixel simple neural attentive learner (pixelSNAIL), a self-attention model, or an image-transformer model. Some of these ML models may be considered RCNNs. Further, an LSTM may be a row LSTM or diagonal biLSTM among others. Further still, an LSTM may be included within one or more of the ML models thereof.

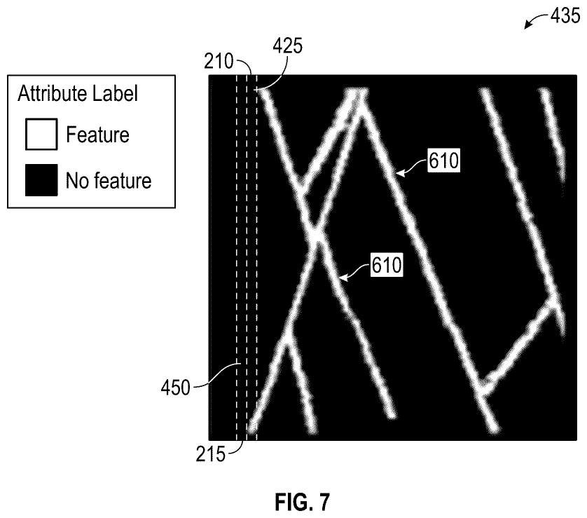

Following the selection of the ML model and associated hyperparameters, training, and validation, the ML model may be deployed for use. FIG. 7 displays a predicted feature image 435, in accordance with one or more embodiments, produced from a trained ML model. Here, the predicted feature image 435 displays labeled manifestations of a feature 610 that appear as unlabeled manifestations of the feature 205 within the seismic image 200 shown in FIG. 2. Further, the predicted feature predicted image 435 displays labeled manifestations of the feature 610 using a binary system where, now, a black pixel indicates no manifestation of the feature and a white pixel indicates manifestation of the feature. Further note that here, each of the sequence of N windows are a column of pixels. As such, the nth predicted feature image is displayed with the nth window 210 and the (n−1)th predicted feature image is displayed with the (n−1)th window 215.

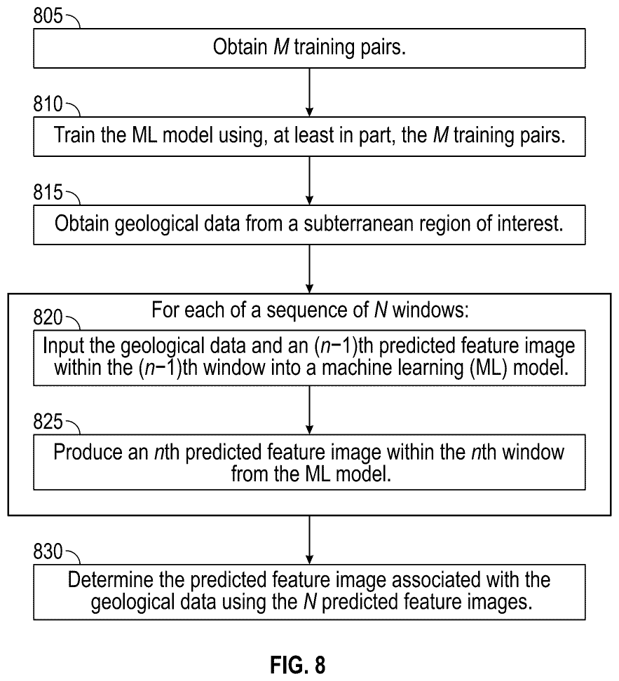

FIG. 8 describes a method in accordance with one or more embodiments. While the method below describes a method of training a ML model and a method of using the ML model, these methods may be performed independently without departing from the scope of the disclosure. The method may be used to ultimately determine a predicted feature image, such as predicted feature image 435, using geological data 415, such as the seismic image 200, and the ML model.

In step 805, M training pairs are obtained. Recall that M is an integer greater than or equal to one. Further recall that m maintains a count of the M training pairs where m is an integer between 1 and M inclusive of 1 and M. For example, if M=3, there are three training pairs that include a first training pair, a second training pair, and a third training pair. The first training pair, second training pair, or third training pair may be referred to generically as the mth training pair among the M training pairs. Further, recall each mth training pair includes an mth training geological data patch and an associated mth training feature image patch. The mth training geological data patch includes an mth training seismic image patch, such as the mth training seismic image patch 600. The mth training geological data patch may additionally include one or more mth training well log patches, an mth training seismic velocity model patch, and/or one or more mth training facies information patches. Each associated mth training feature image patch, such as the associated mth training feature image patch 605, may be determined from the mth training geological data patch manually by an interpreter, automatically by any of the current methods previously discussed, or by any combination of manual and automatic methods. The M training pairs may be two-dimensional or higher dimensionality patches. In practice, thousands to millions of (or even more) training pairs may be obtained.

Each of the M training geological data patches include an mth manifestation of a feature 205. Further, each of the associated M training feature image patches include an mth labeled manifestation of the feature 610.

In step 810, the ML model is trained using the M training pairs. The ML model may be autoregressive, stochastic, or both. Further, the ML model may be trained using the M training pairs and the backpropagation process previously described. Recall that the ML model is trained to produce an nth predicted feature image within an nth window, such as the nth predicted feature image 425, from geological data 415. The geological data 415 includes an unlabeled manifestation of a feature 205. The feature may be a fault 120 or a horizon 110 among other features within a subterranean region of interest 100. The nth predicted feature image 425 within the nth window 210 includes a labeled manifestation of the feature 610. In some embodiments, the nth predicted feature image 425 may be a binary image that assigns one color to a pixel if the feature exists at that pixel location and another color to a pixel if the feature does not exist at that pixel location. In other embodiments, the nth predicted feature image 425 may be a display of values of an attribute, such as semblance.

In step 815, the geological data 415 is obtained from the subterranean region of interest 100. Recall that the geological data 415 includes a seismic image, such as seismic image 200. The seismic image may be obtained during a seismic survey as described in FIG. 1. The geological data 415 may additionally include one or more well logs, a seismic velocity model, and/or facies information. The one or more well logs may be obtained using a well logging system 305 as described in FIG. 3. The seismic velocity model may be obtained from the seismic survey, a VSP survey, and/or a checkshot survey. The facies information may be obtained from outcrops and/or rock cores. Further, the geological data 415 includes a manifestation of a feature within the subterranean region of interest 100.

Steps 820 and 825 are repeated for each of the sequence of N windows. Recall that N is an integer greater than or equal to one. Further recall that n maintains a count of the N windows where n is an integer between 1 and N inclusive of 1 and N. For example, assume N=3. Then a first window, second window, and third window make up the sequence of three windows. The first window, second window, or third window may be generically referred to as the nth window. Further, if n=3, the nth window is the third window and the (n−1)th window is the second window.

Each nth window may be a collection of one or more neighboring pixels, a collection of one or more neighboring columns of pixels (as shown in FIGS. 2 and 7), a collection of one or more neighboring rows of pixels, a collection of one or more neighboring vertical planes of pixels, or a collection of one or more neighboring horizontal planes of pixels. A collection of one or more vertical planes of pixels may be referred to as an in-line section or crossline section depending on the orientation of the planes. A collection of one or more neighboring horizontal planes of pixels may be referred to as a time-slice section.

In step 820, the geological data 415 and at least an (n−1)th predicted feature image within an (n−1)th window is input into the ML model. Note that for n=1 (i.e., the base case), only the geological data 415 is input into the ML model as the 0^{th} predicted feature image within the 0^{th} window do not exist since N≥1. In some embodiments, the geological data 415 and some or all of the predicted feature images smaller than n may be input into the ML model.

In step 825, the nth predicted feature image within an nth window is produced from the ML model. The process described in steps 820 and 825 may be referred to as an autoregressive process.

In step 830, a predicted feature image 435 is determined using the N predicted feature images produced in step 825. The predicted feature image 435 includes a labeled manifestation of the feature 610 that is unlabeled with the geological data 415 and present within the subterranean region of interest 100.

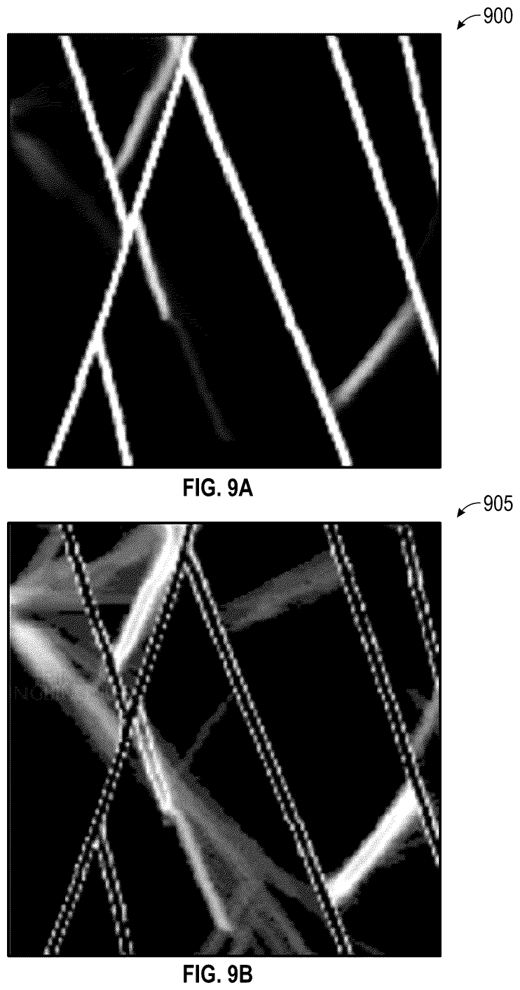

When the ML model is stochastic, steps 820, 825, and 830 may be repeated to determine a new predicted feature image that may be different from the predicted feature image 435. In practice, steps 820, 825, and 830 may be repeated x number of times to predict x number of new predicted feature images for the same geological data 415. Because of the stochastic nature of a stochastic ML model, each new predicted feature image may be different than any other new predicted feature image or the predicted feature image. Thus, the predicted feature image and the new predicted feature image(s) may be used to perform an uncertainty analysis. Uncertainty analysis may be performed by determining a predicted probabilistic feature image using the predicted feature image and the new predicted feature image(s). FIGS. 9A and 9B each displays a predicted probabilistic feature image in accordance with one or more embodiments. Specifically, FIG. 9A displays an average predicted probabilistic feature image 900 determined from 100 predicted feature images. The average predicted probabilistic feature image 900 is shown in grayscale. Here a white pixel indicates that every predicted feature image out of the 100 predicted feature images display the feature at that pixel location. A black pixel indicates that every predicted feature image out of the 100 predicted feature images did not display the feature at that pixel location. FIG. 9B displays a standard deviation predicted probabilistic feature image 905 determined from the 100 predicted feature images. The standard deviation predicted probabilistic feature image 905 is also shown in grayscale. Here a white pixel indicates the maximum standard deviation determined between the 100 predicted feature images. A black pixel indicates that every predicted feature image out of the 100 predicted feature images either did or did not display the feature. As such, the standard deviation at these pixel locations may be zero or the minimum standard deviation determined between the 100 predicted feature images. Specifically, black pixels not outlined with a dotted white line did not display the feature. Black pixels outlined with a dotted white line did display the feature. A person of ordinary skill in the art will appreciate that the predicted probabilistic feature image may quantify statistical measures other than average and standard deviation, such as a probability, without departing from the scope of this disclosure.

Following the determination of a predicted feature image, such as predicted feature image 435, and/or one or more predicted probabilistic feature images, the image(s) may be used, at least in part, to inform a geological model, geophysical model, and/or geomechanical model (hereinafter “models”) that models the subterranean region of interest 100. As such, the models may then include the location and size of features labeled within the predicted feature image and/or probabilistic feature image(s). In turn, the models may be used to aid in the planning of a wellbore path 150. The models may also be used, at least in part, to plan injection wellbore paths and infill wellbore paths within the subterranean region of interest 100 among other activities.

The predicted feature image and predicted probabilistic feature image(s) may also be used separate from models to identify a location and size of a drilling target 145 within the hydrocarbon reservoir 115 within the subterranean region of interest 100. As previously described, the drilling target 145 may be a compartment 140 within the hydrocarbon reservoir 115 that often contains hydrocarbons. The drilling target 145 may be identified based on the labeled manifestations of the feature 610 within the predicted feature image and other information associated with hydrocarbon flow, such as permeability. In some embodiments, an interpreter may manually identify the location and size of the drilling target 145 using a seismic interpretation workstation as will be described in reference to FIG. 11.

Following the identification of the location and size of the drilling target 145 using the predicted feature image, a wellbore path 150 may be planned, using a wellbore planning system, to intersect the drilling target 145. The wellbore plan may be additionally informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes 132.

A wellbore plan may include a starting surface location of the wellbore, or a subsurface location within an existing wellbore, from which the wellbore may be drilled. The wellbore plan may further include a terminal location that may intersect with the drilling target 145 within the previously located hydrocarbon reservoir 115. The wellbore plan may further still include wellbore geometry information such as wellbore diameter and inclination angle. If casing is used, the wellbore plan may include casing type or casing depths. Furthermore, the wellbore plan may consider other engineering constraints such as the maximum wellbore curvature (“dog-log”) that a drillstring may tolerate and the maximum torque and drag values that the drilling system may tolerate.

The wellbore planning system may be used to generate the wellbore plan. The wellbore planning system may use one or more computer processors in communication with computer memory containing models, the predicted feature image, information relating to drilling hazards, and the constraints imposed by the limitations of the drillstring and the drilling system. The wellbore planning system may further include dedicated software to determine the planned wellbore path 150 and associated drilling parameters, such as the planned wellbore diameter, the location of planned changes of the wellbore diameter, the planned depths at which casing will be inserted to support the wellbore and to prevent formation fluids entering the wellbore, and the drilling mud weights (densities) and types that may be used during drilling of the wellbore.

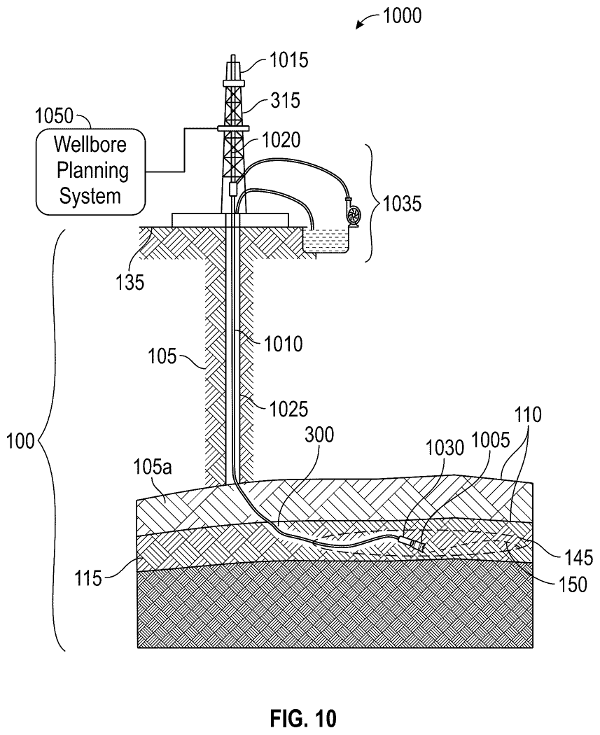

The planned wellbore path 150 may then be drilled, using a drilling system, guided by the wellbore path 150 to penetrate the drilling target 145. FIG. 10 shows a drilling system 1000 in accordance with one or more embodiments. Although the drilling system 1000 shown in FIG. 10 is used to drill a wellbore 300 on land, the drilling system 1000 may also be a marine wellbore drilling system. The example of the drilling system 1000 shown in FIG. 10 is not meant to limit the present disclosure.

As shown in FIG. 10, the wellbore 300 may be drilled using a drill rig that may be situated on a land drill site, an offshore platform, such as a jack-up rig, a semi-submersible, or a drill ship. The drill rig may be equipped with a hoisting system, such as a derrick 315, which can raise or lower the drillstring 1010 and other tools required to drill the wellbore 300. The drillstring 1010 may include one or more drill pipes connected to form conduit and a bottom hole assembly (BHA) 1030 disposed at the distal end of the drillstring 1010. The BHA 1030 may include a drill bit 1005 to cut into rock 105, including cap rock 105a. The BHA 1030 may further include measurement tools, such as a measurement-while-drilling (MWD) tool and logging-while-drilling (LWD) tool. MWD tools may include sensors and hardware to measure downhole drilling parameters, such as the azimuth and inclination of the drill bit 1005, the weight-on-bit, and the torque. The LWD measurements may include sensors, such as resistivity, gamma ray, and neutron density sensors, to characterize the rock 105 surrounding the wellbore 300. Both MWD and LWD measurements may be transmitted to the surface of the earth 135 using any suitable telemetry system known in the art, such as a mud-pulse or by wired-drill pipe.

To start drilling, or “spudding in,” the wellbore 300, the hoisting system lowers the drillstring 1010 suspended from the derrick 315 towards the planned surface location of the wellbore 300. An engine, such as a diesel engine, may be used to supply power to the top drive 1015 to rotate the drillstring 1010 via the drive shaft 1020. The weight of the drillstring 1010 combined with the rotational motion enables the drill bit 1005 to bore the wellbore 300.

The near-surface of the subterranean region of interest 100 is typically made up of loose or soft sediment or rock 105, so large diameter casing 1025 (e.g., “base pipe” or “conductor casing”) is often put in place while drilling to stabilize and isolate the wellbore 300. At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface of the earth 135.

Drilling may continue without any casing 1025 once deeper, or more compact rock 105 is reached. While drilling, a drilling mud system 1035 may pump drilling mud from a mud tank on the surface of the earth 135 through the drill pipe. Drilling mud serves various purposes, including pressure equalization, removal of rock cuttings, and drill bit cooling and lubrication.

At planned depth intervals, drilling may be paused and the drillstring 1010 withdrawn from the wellbore 300. Sections of casing 1025 may be connected and inserted and cemented into the wellbore 300. Casing string may be cemented in place by pumping cement and mud, separated by a “cementing plug,” from the surface of the earth 135 through the drill pipe. The cementing plug and drilling mud force the cement through the drill pipe and into the annular space between the casing 1025 and the wall of the wellbore 300. Once the cement cures, drilling may recommence. The drilling process is often performed in several stages. Therefore, the drilling and casing cycle may be repeated more than once, depending on the depth of the wellbore 300 and the pressure on the walls of the wellbore 300 from surrounding rock 105.

Due to the high pressures experienced by deep wellbores 300, a blowout preventer (BOP) may be installed at the wellhead to protect the rig and environment from unplanned oil or gas releases. As the wellbore 300 becomes deeper, both successively smaller drill bits 1005 and casing string may be used. Drilling deviated or horizontal wellbores 300 may require specialized drill bits 1005 or drill assemblies.

A drilling system 1000 may be disposed at and communicate with other systems in the well environment. The drilling system 1000 may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target 145 is reached or the presence of hydrocarbons is established.

FIG. 11 illustrates a computer system 1105 in accordance with one or more embodiments. The computer 1105 may be specifically configured for seismic processing and denoted a “seismic processing system.” For example, the method described in FIG. 8 may be performed on a seismic processing system. Alternatively, the computer 1105 may be specifically configured for seismic interpretation and denoted a “seismic interpretation workstation.” For example, identifying the drilling target 145 within the hydrocarbon reservoir 115 using the predicted feature image may be performed, at least in part, using a seismic interpretation workstation. While the generic term computer 1105 may be used to describe the parts of a computer 1105 in the following paragraphs, the terms seismic processing system or seismic interpretation workstation may replace the term computer 1105 without departing from the scope of the disclosure.

The computer 1105 is intended to depict any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 1105 may include an input device, such as a keypad, keyboard, touch screen, or other device that can accept user information, and an output device that displays information, including digital data, visual or audio information (or a combination of both), or a graphical user interface. Specifically, a seismic interpretation workstation may include a robust graphics card for the detailed rendering of the seismic image patches 600, predicted feature image, and/or predicted probabilistic feature image 900, 905 such that the images(s) may be displayed and manipulated in a virtual reality system using 3D goggles, a mouse, or a wand. In turn, each seismic image patch 600 may be manipulated to determine the associated feature image patch 605. Further, the predicted feature image and/or predicted probabilistic feature image 900, 905 may be manipulated to identify the drilling target 145 within the hydrocarbon reservoir 115 and possibly drilling hazards within the subterranean region of interest 100.

The computer 1105 can serve in a role as a client, network component, server, database, or any other component (or a combination of roles) of a computer system 1105 as required for seismic processing and seismic interpretation. The illustrated computer system 1105 is communicably coupled with a network 1110. For example, a seismic processing system and a seismic interpretation workstation may be communicably coupled using a network 1110. In some implementations, one or more components of each computer system 1105 may be configured to operate within environments, including cloud-computing-based, local, global, or other environment (or a combination of environments).

At a high level, the computer system 1105 is an electronic computing device operable to receive, transmit, process, store, and/or manage data and information associated with seismic processing and seismic interpretation. According to some implementations, the computer system 1105 may also include or be communicably coupled with an application server, e-mail server, web server, caching server, streaming data server, business intelligence (BI) server, or other server (or a combination of servers).

Because seismic processing and seismic interpretation may not be sequential, the computer system 1105 can receive requests over network 1110 from other computer systems 1105 or another client application and respond to the received requests by processing the requests appropriately. In addition, requests may also be sent to the computer system 1105 from internal users (for example, from a command console or by other appropriate access method), external or third-parties, other automated applications, as well as any other appropriate entities, individuals, systems, or computer systems 1105.

Each of the components of the computer system 1105 can communicate using a system bus 1115. In some implementations, any or all of the components of each computer system 1105, both hardware or software (or a combination of hardware and software), may interface with each other or the interface 1120 (or a combination of both) over the system bus 1115 using an application programming interface (API) 1012 or a service layer 1130 (or a combination of the API 1125 and service layer 1130. The API 1125 may include specifications for routines, data structures, and object classes. The API 1125 may be either computer-language independent or dependent and refer to a complete interface, a single function, or even a set of APIs. The service layer 1130 provides software services to each computer system 1105 or other components (whether or not illustrated) that are communicably coupled to each computer system 1105. The functionality of each computer system 1105 may be accessible for all service consumers using this service layer 1130. Software services, such as those provided by the service layer 1130, provide reusable, defined business functionalities through a defined interface. For example, the interface may be software written in JAVA, C++, or other suitable language providing data in extensible markup language (XML) format or another suitable format. While illustrated as an integrated component of each computer system 1105, alternative implementations may illustrate the API 1125 or the service layer 1130 as stand-alone components in relation to other components of each computer system 1105 or other components (whether or not illustrated) that are communicably coupled to each computer system 1105. Moreover, any or all parts of the API 1125 or the service layer 1130 may be implemented as child or sub-modules of another software module, enterprise application, or hardware module without departing from the scope of this disclosure.

The computer system 1105 includes an interface 1120. Although illustrated as a single interface 1120 in FIG. 11, two or more interfaces 1120 may be used according to particular needs, desires, or particular implementations of each computer system 1105. The interface 1120 is used by each computer system 1105 for communicating with other systems in a distributed environment that are connected to the network 1110. Generally, the interface 1120 includes logic encoded in software or hardware (or a combination of software and hardware) and operable to communicate with the network 1110. More specifically, the interface 1120 may include software supporting one or more communication protocols associated with communications such that the network 1110 or interface's hardware is operable to communicate physical signals within and outside of the illustrated computer 1105.

The computer system 1105 includes at least one computer processor 1135. Generally, a computer processor 1135 executes any instructions, algorithms, methods, functions, processes, flows, and procedures as described above. A computer processor 1135 may be a central processing unit (CPU) and/or a graphics processing unit (GPU). Seismic data used to determine the seismic image 200 and/or the seismic image patches 600 may be hundreds of terabytes in size. To efficiently process the seismic data and determine the seismic image 200 and/or seismic image patches 600, a seismic processing system may consist of an array of CPUs with one or more subarrays of GPUs attached to each CPU. Further, tape readers or high-capacity hard-drives may be connected to the CPUs using wide-band system buses 1115.

The computer system 1105 also includes a memory 1140 that stores data and software for the computer system 1105 or other components (or a combination of both) that can be connected to the network 1110. For example, the memory 1140 may store the wellbore planning system 1050 in the form of software. Although illustrated as a single memory 1140 in FIG. 11, two or more memories may be used according to particular needs, desires, or particular implementations of the computer system 1105 and the described functionality. While memory 1140 is illustrated as an integral component of each computer system 1105, in alternative implementations, memory 1140 can be external to each computer system 1105.

The application 1145 is an algorithmic software engine providing functionality according to particular needs, desires, or particular implementations of the computer system 1105, particularly with respect to functionality described in this disclosure. For example, application 1145 can serve as one or more components, modules, applications, etc. Further, although illustrated as a single application 1145, the application 1145 may be implemented as multiple applications 1145 on each computer system 1105. In addition, although illustrated as integral to each computer system 1105, in alternative implementations, the application 1145 can be external to each computer system 1105.

There may be any number of computers 1105 associated with, or external to, a seismic processing system and a seismic interpretation workstation, where each computer system 1105 communicates over network 1110. Further, the term “client,” “user,” and other appropriate terminology may be used interchangeably as appropriate without departing from the scope of this disclosure. Moreover, this disclosure contemplates that many users may use the computer system 1105, or that one user may use multiple computer systems 1105.

A summary of the systems 1200 associated to the method is illustrated in FIG. 12 in accordance with one or more embodiments.

In some embodiments, a seismic acquisition system 155 may be configured to obtain the seismic image, the M training seismic image patches, the seismic velocity model, and/or the M training seismic velocity model patches for the subterranean region of interest 100 as described relative to FIG. 1.

The seismic image, the M training seismic image patches, the seismic velocity model, the M training seismic velocity model patches as well as other data associated to the M training pairs and/or the geological data may be input into, stored on, and processed using the seismic processing system 1105a. Processing may include attenuating artifacts and amplifying manifestations of features within the subterranean region of interest 100. Further, the seismic processing system 1105a may be used to perform the methods described in the present disclosure to train the ML model, determine a predicted feature image, and/or determine a predicted probabilistic feature image.

The predicted feature image and/or the predicted probabilistic feature image may be transferred to and stored on the seismic interpretation workstation 1105b via the network 1110 as described relative to FIG. 11. The predicted feature image and/or the predicted probabilistic feature image may then be displayed on the seismic interpretation workstation 1105b. The predicted feature image and/or the predicted probabilistic feature image may display the labeled manifestations of the feature 610 within the subterranean region of interest 100. A seismic interpreter may then manually manipulate the predicted feature image and/or the predicted probabilistic feature image using the seismic interpretation workstation 1105b to identify and label a drilling target 145 within the hydrocarbon reservoir 115 within the subterranean region of interest 100.

The labeled predicted feature image and/or the predicted probabilistic feature image may then be loaded into the wellbore planning system 1050 that may be located on a memory 1140 of a computer 1105. A user of the computer 1105 may use the labeled predicted feature image and/or the predicted probabilistic feature image loaded into the wellbore planning system 1050 to plan a wellbore path 150 that penetrates the hydrocarbon reservoir 115.

The planned wellbore path 150 may be loaded into the drilling system 1000 discussed in reference to FIG. 10. The drilling system 1000 may be configured to drill a wellbore 300 within the subterranean region of interest 100 guided by the planned wellbore path 150. Following drilling and completion of the wellbore 300, the wellbore 300 may be used to produce hydrocarbons from the hydrocarbon reservoir 115 to the surface of the earth 135.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method of training a machine learning (ML) model comprising:
obtaining M training pairs,
wherein each of the M training pairs comprises an mth training geological data patch and an associated mth training feature image patch,
wherein the mth training geological data patch comprises:
an mth training seismic image patch; and
an mth manifestation of a feature, and
wherein the associated mth training feature image patch comprises an mth labeled manifestation of the feature; and
training the ML model using, at least in part, the M training pairs,
wherein the ML model is trained to produce an nth predicted feature image within an nth window from, at least in part, geological data, and
wherein M and N are integers greater than or equal to one,
wherein m is an integer between 1 and M, inclusive, and
wherein n is an integer between 1 and N, inclusive.

2. The method of claim 1, further comprising:
for each of a sequence of N windows:
inputting the geological data and an (n−1)th predicted feature image within an (n−1)th window into the ML model, and
producing the nth predicted feature image within the nth window from the ML model; and
determining a predicted feature image for the geological data associated with a subterranean region of interest using the N predicted feature images,
wherein the predicted feature image comprises a labeled manifestation of the feature.

3. The method of claim 1, wherein the mth training geological data patch further comprises an mth training seismic velocity model patch.

4. The method of claim 1, wherein the feature comprises a fault.

5. The method of claim 1, wherein the ML model comprises a recurrent convolutional neural network.

6. The method of claim 1, wherein the ML model is stochastic.

7. A method of determining a predicted feature image comprising:
obtaining geological data from a subterranean region of interest,
wherein the geological data comprises:
a seismic image; and
a manifestation of a feature within the subterranean region of interest;
for each of a sequence of N windows,
wherein N is an integer greater than or equal to one, and
wherein n is an integer between 1 and N, inclusive:
inputting the geological data and an (n−1)th predicted feature image within an (n−1)th window into a machine learning (ML) model, and
producing an nth predicted feature image within an nth window from the ML model; and
determining the predicted feature image for the geological data associated with the subterranean region of interest using the N predicted feature images,
wherein the predicted feature image comprises a labeled manifestation of the feature.

8. The method of claim 7, further comprising:
identifying a drilling target within a hydrocarbon reservoir within the subterranean region of interest based, at least in part, on the predicted feature image; and
planning a wellbore path based, at least in part, on the drilling target.

9. The method of claim 8, further comprising drilling a wellbore guided by the wellbore path.

10. The method of claim 7, wherein the ML model comprises a recurrent convolutional neural network.

11. The method of claim 7, wherein the ML model is stochastic.

12. The method of claim 11, further comprising:
for each of the sequence of N windows:
inputting the geological data and a new (n−1)th predicted feature image within the (n−1)th window into the ML model, and
producing a new nth predicted feature image within the nth window from the ML model;
determining a new predicted feature image for the geological data associated with the subterranean region of interest using the new N predicted feature images; and
determining a predicted probabilistic feature image for the geological data associated with the subterranean region of interest using the new predicted feature image and the predicted feature image.

13. The method of claim 7, wherein the geological data further comprises a seismic velocity model.

14. The method of claim 7, wherein the feature comprises a fault.

15. The method of claim 7, wherein the predicted feature image comprises a two-dimensional spatial display of values of an attribute.

16. The method of claim 7, wherein each of the sequence of N windows comprises a column of pixels.

17. A system comprising:
a seismic processing system configured to:
receive geological data from a subterranean region of interest,
wherein the geological data comprises:
a seismic image, and
a manifestation of a feature within the subterranean region of interest,
for each of a sequence of N windows,
wherein N is an integer greater than or equal to one, and
n is an integer between 1 and N, inclusive:
input the geological data and an (n−1)th predicted feature image within an (n−1)th window into a machine learning (ML) model; and
produce an nth predicted feature image within an nth window from the ML model, and
determine a predicted feature image for the geological data associated with the subterranean region of interest using the N predicted feature images,
wherein the predicted feature image comprises a labeled manifestation of the feature; and
a seismic interpretation workstation configured to:
identify a drilling target within a hydrocarbon reservoir within the subterranean region of interest based, at least in part, on the predicted feature image.

18. The system of claim 17, further comprising a wellbore planning system configured to plan a wellbore path based, at least in part, on the drilling target.

19. The system of claim 18, further comprising a drilling system configured to drill a wellbore guided by the wellbore path.

20. The system of claim 17, further comprising a seismic acquisition system configured to obtain the seismic image.
